(19) United States
(12) Patent Application Publication
(10) Pub. No.: US 2004/0042036 A1
(43) Pub. Date: Mar. 4, 2004

(54) Processor

(75) Inventors: Nobuyuki Kodera, Kanagawa (JP); Tsuyoshi Yaguchi, Kanagawa (JP); Keiji Yamanaga, Kanagawa (JP); Wataru Minami, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/388,745

(22) Filed: Mar. 17, 2003

(30) Foreign Application Priority Data
Aug. 29, 2002 (JP) 2002-250589

(51) Int. Cl. G06F 3/12; G06F 13/00; H04B 10/04

(52) U.S. Cl. 358/1.15; 398/182

(57) ABSTRACT

After parallel data is converted into serial data by the converter 402, the serial data is converted into an optical signal by the photoelectric converter 404, and this optical signal is incident on the optical fiber 410. When the optical signal passes in the optical fiber 410, it is received by the photoelectric converter 424 on the opposite side and converted into serial data. After this serial data is converted into parallel data by the converter 422, it is inputted onto the video board 427. When the optical transmission technique is adopted, even if a plurality of functional modules are arranged distant from each other, the problems of electromagnetic interference, electro magnetic emission, adaptability to the electromagnetic environment and deformation of a wave-form are not caused.

### BACKGROUND OF THE INVENTION

The present invention relates to a processor, which conducts predetermined processing, such as an image forming section in which an image is formed on a predetermined recording medium according to image data inputted. More particularly, the present invention relates to transmission of an electric signal in a processor or between circuit modules arranged between processors.

Image forming apparatus having a printing function such as printers and copiers are used in various fields. Nowadays, color image forming apparatus are developed and used as an expression means by users. For example, a color page printer using an electrophotographic process (xerography) is being watched with keen interest from the viewpoint of high quality and high printing speed.

On the other hand, from the viewpoint of a printing function, the image forming apparatus are roughly divided into two types. One is a type in which a relatively small scale printing output (for example, printing output of several to several tens sheets per one job) for private use in home or for business use in office is required. The other is a type in which a relatively large scale printing output (for example, printing output more than several thousand sheets) for printing industry use is required. In the former type in which the relatively small printing output is required, except for the case of a mimeograph, in most cases, printing data is received and printed matters are outputted without making a block copy. On the other hand, in the latter type in which the relatively large printing output is required, it is conventional that a block copy is made according to the printing data, and printed matters are outputted while using thus made block copy.

However, nowadays, DTP (Desk Top Publishing/Prepress) widely spreads, and the printing process is changed. Due to “Digital Revolution of Printing”, attention is paid to “Direct Printing” or “On-Demand Printing” in which printing is directly conducted by DTP data. In this “On-Demand Printing”, different from the conventional printing method (for example, offset printing), an intermediate printed matter such as a photographic paper in phototypesetting, block copy, halftone negative, halftone positive or PS is not made and a printed matter is outputted only according to electronic data when the prepress process is completely digitized, that is, a system CTP (Computer To Print or Paper) is adopted. In order to meet the demand of this On-Demand Printing, attention is paid to a printing function in which an electrophotographic process is used.

FIG. 11 is a view showing an outline of the image forming system provided with an example of the conventional image forming apparatus. In this case, FIG. 11A is an overall arrangement view of the system. Items (B1) to (B3) in FIG. 11B are views showing a user interface in detail.

This image forming system includes: an image forming apparatus 1; and DFE (Digital Front End Processor) which is a terminal to give a printing direction by sending printing data to the image forming apparatus 1.

The image forming apparatus 1 records an image on a predetermined recording medium by utilizing an electrophotographic process. The image forming apparatus 1 includes: IOT (Image Output Terminal) module 2; a feed (paper feed) module (FM: Feeder module) 5; an output module 7; a user interface 8; and a connecting module 9 to connect IOT module 2 with the field module 5.

DFE device is provided with a printer controller function. DFE device is operated as follows. DFE device receives printing data described by PDL (Page Description Language), which is capable of freely controlling enlargement, rotation and deformation of figures and characters, from a client terminal, and this printing data is converted into a raster image (RIP Process: Raster Image Process), and image data subjected to RIP process and printing control information (job ticket) such as a printing number and paper size are sent to the image forming apparatus 1 so that a print engine of the image forming apparatus 1 and a paper transporting system are controlled and the image forming apparatus 1 is made to carry out printing processing. That is, printing operation of the image forming apparatus 1 is controlled by the printer controller function of DFE.

Concerning the printing data, the printing data of four colors of yellow (Y), cyan (C) and magenta (M), which are basic colors of color printing, and black (K) is sent to the image forming apparatus 1. In this case, yellow, cyan, magenta and black are generally called Y, M, C and K.

The user interface 8 is provided so that an operator can have an understandable conversation with the image forming apparatus 1. In order to enhance the operation property, as shown in FIG. 11B in detail, there are provided a color display 8a and a hard control panel 8b arranged on the side of the color display 8a. Due to the color display, the operator can be provided with an understandable menu. Since the color display 8a is combined with the touch panel 893, the operator can directly gain access to the image forming apparatus with soft buttons on the image plane. The touch panel 893 is attached to the bezel 892 surrounding the face section of CRT 891. When the contents of operation are effectively distributed to the hard button of the hard control panel 8b and the soft buttons displayed on the image plane of the color display 8a, operation can be simplified and the menu image plane can be effectively composed.

The base board 894 for monitor control and for the electric power source, the engine base board 895 for the user interface 8 and the driver base board 896 for CRT 891 are mounted on the back side of the color display 8a and the hard control panel 8b. The hard control panel 8b can be turned to the central portion more than the face of the color display 8a. As shown in the drawing, the color display 8a and the hard control panel 8b are not directly attached to the base machine 890 (the apparatus body, in this example, the connecting module 9) but are attached to the support arm 8c rising from the base machine.

IOT module 2 includes IOT core section 20 and the toner supplier 22. In the toner supplier 22, the toner cartridges 24 of Y, M, C and K used for color printing are mounted.

IOT core section 20 is provided with a print engine (printing unit) 30 having an optical scanning device 31 and also having photoreceptor drum 32 for each color component described above. These print engines 30 are arranged in the transporting direction in a line, that is, these print engines 30 are arranged in tandem. IOT core section 20 is provided with an electric system control accommodating section 39 in which an electric circuit to control each print engine 30 and an electric power source circuit for each module are accommodated.

IOT core section 20 uses an image transfer system in which a toner image on the photoreceptor drum 32 is transferred onto the intermediate transfer belt 43 (primary transfer) by the primary transfer unit 35 and then the toner image on the intermediate transfer belt 43 is transferred onto a sheet of printing paper (secondary transfer) by the secondary transfer unit 45. In the above arrangement, image formation is conducted by toner of each color Y, M, C, K on each photoreceptor drum 32, and the toner image of each color formed on each photoreceptor drum 32 is successively transferred onto the intermediate transfer belt 43 so that a multiple toner image can be formed. After that, the multiple toner image is transferred onto a predetermined sheet of printing paper. In this way, a color image can be formed.

For example, in the print engine 30, first of all, the optical scanning device 31 conducts scanning on a face to be scanned of the photoreceptor drum 32, which is electrically charged with a laser beam modulated by image information, so that an electrostatic latent image can be formed on the photoreceptor drum 32. This electrostatic latent image is visualized as a toner image by the developing unit 34 of each color, to which each color toner of Y, M, C or K is supplied. The thus obtained toner image is transferred onto the intermediate belt 43 by the primary transfer unit 35.

In accordance with this transfer of the color toner image onto the intermediate transfer belt 43, in the field module 5, a sheet of printing paper is drawn out from the sheet tray 52 and delivered to the first transport path 47 of IOT module 2. The first transport path 47 has a registration function (Regi/Aligner). Therefore, the first transport path 47 supplies the sheet of printing paper to the secondary transfer section 45 in accordance with the writing position on the sheet of printing paper.

The image (toner image) transferred onto the intermediate transfer belt 43 is transferred onto the sheet of printing paper transported from the field module 5 at a predetermined time. Further, the sheet of printing paper onto which the toner image is transferred is transported to the fuser 70 by the second transport path 48, and the toner image can be fused onto the sheet of printing paper by this fuser 70. After that, the sheet of printing paper is temporarily, held in the stacker (discharged sheet tray) 74 or immediately delivered to the discharged sheet processing device 72 and discharged outside the apparatus if necessary after it is subjected to a necessary process. In the case of two-side printing, a sheet of printing paper, on which a color image is already printed, is drawn out from the discharged sheet tray 74 to the reversal path 76 and delivered to the reversal transport path 49 of IOT module 2.

FIG. 12 is a view showing an example of the arrangement of the circuit module of the image forming apparatus 1 shown in FIG. 11. As shown in the drawing, the circuit module is divided into the circuit module for IOT core section 20 and the circuit module for the field module 5. The circuit module for IOT core section 20 is accommodated in the electric system control accommodating section 39, and the circuit module for the field module 5 is accommodated in the field module 5.

The circuit module for IOT core section 20 includes: a marking section MK which is a primary section relating to image formation (image data generation and image data processing); a sheet supply controller PH relating to sheet transportation; a fusing section FU relating to control of the fuser 70; a sheet discharge section EX relating to a portion for discharging a sheet of printed paper to the outside of the apparatus; an IOT controller CT to control each section in IOT core section 20; and an electric power circuit PW to supply electric power to each section.

Each section described above is mounted on printed wiring board PWB. IOT controller CT and each section described above are connected with each other by the driver circuit. The circuit module for IOT core section 20 is connected with the user interface 8 via I/F controller.

In this connection, nowadays, there is a demand of enhancing the performance and processing speed of an image forming process (printing process). For example, the following techniques are proposed. Concerning the printer controller provided in DFE device, when CPU of high processing speed and high performance is mounted in the controller, data can be generated at high speed by which the print engine speed is effectively utilized. Therefore, it is possible to conduct a high speed full color printing operation in which the productivity from giving a command of printing to outputting a printed image is supported. For example, it becomes possible to realize a system in which color printing can be conducted at a printing speed not less than 100 to 200 sheets/minute.

In order to meet the demand of enhancing the performance and processing speed, not only DFE device is improved so that the performance and processing speed can be enhanced but also the image forming apparatus 1 must be improved so that the performance and processing speed can be enhanced and also the function can be multiplied. For example, there is a demand that a four tandem arrangement, in which color materials of four colors are used, is enhanced to a five or more tandem arrangement in which color materials of five or more colors are used. Further, there is a demand that the processing speed is enhanced to 100 to 200 sheets/min or more. Furthermore, there is a demand that one apparatus is appropriately changed over according to the demanded specification.

However, it becomes difficult for the conventional image forming apparatus 1 to meet the above demands. For example, as described above, most of the circuits composing the image forming apparatus 1 are accommodated in the circuit module for IOT core section 20, and the processing control mechanism is substantially composed of one unit.

When the processing speed is increased, the performance is enhanced and the function is multiplied in this arrangement, even if one portion of the circuit is changed, the entire circuit module of IOT core section 20 must be replaced with a new one, and the design of circuit module board PWB must be changed. As a result, the manufacturing cost is raised.

In the case where it becomes necessary to increase the circuit structure so that the processing speed can be enhanced and the function can be multiplied, a problem may be caused in which a new circuit can not be accommodated on one circuit module board PWB. Since a sufficiently large space is not actually provided in the electric system control accommodating section 39, it is impossible to accommodate the board for this new circuit. In this case, for example, as shown in FIG. 11, it is possible to take countermeasures in which the new circuit board and the presently used circuit board are arranged in a portion close to the user interface 8 shown in FIG. 11.

However, when the circuit board is removed to another place, an unnecessary signal is emitted from a metallic wire such as a copper wire used for a connection line of the circuit. Therefore, the problems of EMI (Electro Magnetic Interference) and EME (Electro Magnetic Emission) can be caused. Further, when the signal wire is extended, the load capacity is increased, and the wave-form is deformed, which deteriorates image quality and furthermore it becomes impossible to appropriately conduct controlling because the control time is shifted.

### SUMMARY OF THE INVENTION

The present invention is accomplished in view of the above circumstances. It is an object of the present invention to provide a processor appropriately used for a system of high performance, the processing speed of which is high and the function of which is multiplied, without causing the problems of electromagnetic interference EMI, electromagnetic emission EME and deformation of wave-forms.

The present invention provides a processor such as an image forming apparatus for forming an image on a predetermined recording medium, that is, the present invention provides a processor to conduct predetermined processing comprising: an optical interface section to get transmission of an electric signal by an optical transmission medium between a plurality of module circuits corresponding to the respective functional portions of the processor.

In this case, the phrase “to get transmission of an electric signal by an optical transmission medium” means that an electric signal is converted into a beam of signal light and the thus converted beam of signal light is made to pass in an optical transmission medium.

For example, in the case of a form in which the functional module circuits are respectively mounted on different circuit boards, the optical interface section gets transmission of an electric signal between the respective circuit boards by the optical transmission medium.

Concerning the optical transmission medium, plastic optical fibers or a sheet-shaped optical transmission bus may be used.

The invention described in the dependent claim stipulates a specific advantageous embodiment of the processor of the present invention.

In the processor composed as described above, the optical interface section gets transmission of an electric signal between the functional module circuits corresponding to the respective functional portions of the processor by the optical transmission medium.

When transmission of a signal is gotten in such a manner that an electric signal is converted into a beam of signal light and the thus converted beam of signal light is made to pass in the optical transmission medium, even if a distance between a plurality of function modules is extended, the problems of electromagnetic interference, adaptability to the electromagnetic environment and deformation of the wave-form are not caused. Accordingly, the degree of freedom can be remarkably extended when positions of arranging the functional module circuits are determined.

### BRIEF DESCRIPTION OF THE DRAWINGS

FIGS. 1A and 1B are views showing the first embodiment of the image forming system having an embodiment of the image forming apparatus of the present invention.

FIGS. 2A and 2B are views showing the second embodiment of the image forming system having an embodiment of the image forming apparatus of the present invention.

FIGS. 3A to 3C are views for explaining a difference between the image forming system of the first embodiment and the image forming system of the second embodiment.

FIG. 4 is a view showing an outline of the overall arrangement of the image forming apparatus of the present invention.

FIGS. 5A and 5B are views showing an example of the constitution of the circuit module of the image forming apparatus shown in FIG. 4.

FIG. 6 is a view showing a specific example of the constitution of the board in the case where an example of the combination of the circuit module shown in FIG. 5 is applied to the image forming device shown in FIG. 2.

FIG. 7 is a view showing the first example of the constitution of the board in the case where an interface mechanism utilizing the optical transmission technique is employed.

FIG. 8 is a view showing the second example of the constitution of the board in the case where an interface mechanism utilizing the optical transmission technique is employed.

FIGS. 9A and 9B are schematic illustrations for explaining a method of getting transmission to a board interface by utilizing an optical transmission medium.

FIGS. 10A to 10C are schematic illustrations for explaining a connecting method of connecting an electric signal to an optical sheet bus.

FIGS. 11A and 11B are views showing an outline of the image forming system having an example of the conventional image forming apparatus.

FIG. 12 is a view showing an example of the constitution of the circuit module of the image forming apparatus shown in FIG. 11.

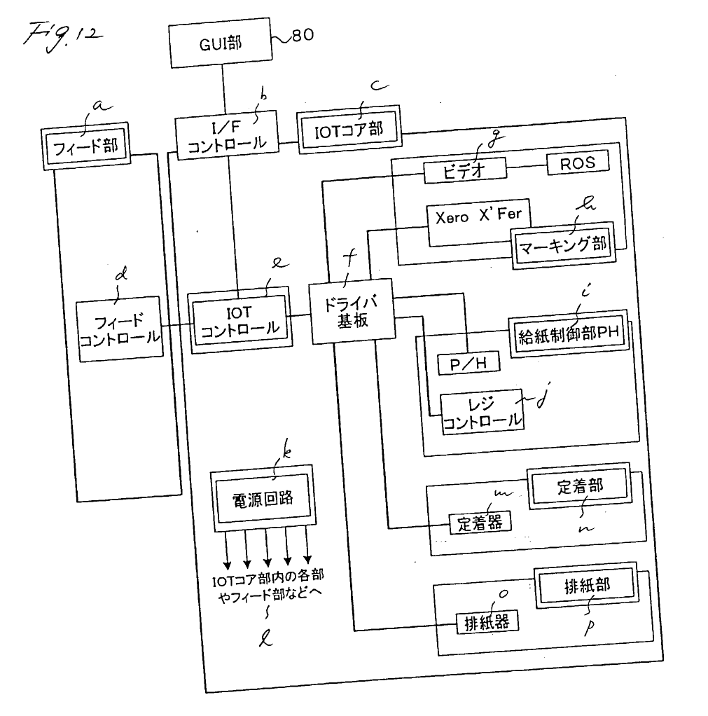

### DETAILED DESCRIPTION OF THE PREFERRED EMBODIMENTS

Referring to the drawings, embodiments of the present invention will be explained in detail as follows.

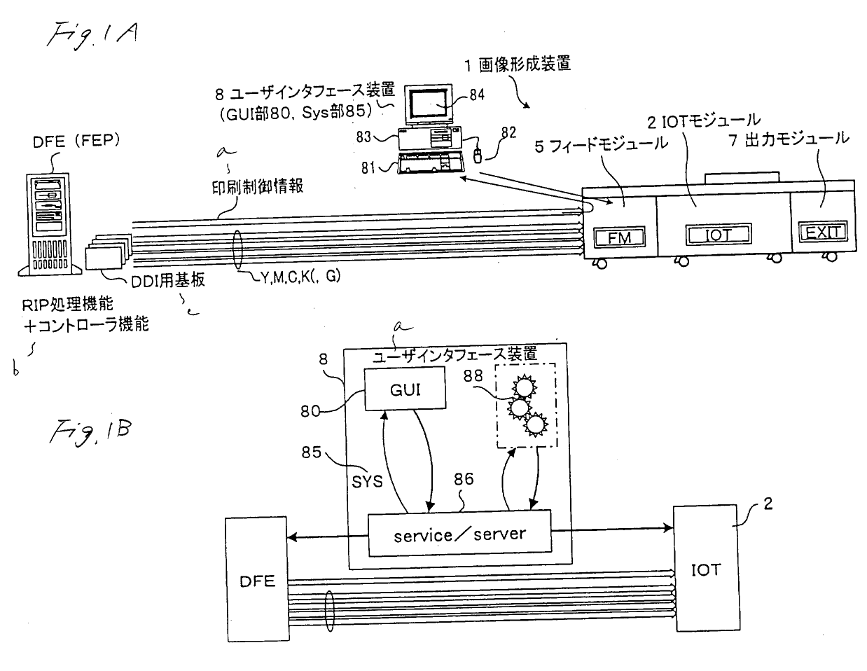

FIG. 1 is a view showing the first embodiment of the image forming system provided with one embodiment of the image forming apparatus of the present invention. In this case, FIG. 1A is a view showing an outline of the system constitution, and FIG. 1B is a view showing an example of the connection with respect to the detail of the user interface device.

This image forming system includes: an image forming apparatus 1; and DFE device which is a terminal device to give a command of printing to the image forming apparatus 1 when printing data is delivered to the image forming apparatus 1.

The image forming apparatus 1 records an image on a predetermined recording medium by means of electrophotographic process (xerography). This image forming apparatus 1 is composed in such a manner that a fuser arranged in IOT module 2 of the conventional apparatus is removed to the exit module 7.

The image forming apparatus 1 of this image forming system includes: IOT module (IOT body) 2; a feed (paper feed) module 5; an output module 7; and a user interface device 8 such as a personal computer (PC). In this connection, the feed module 5 may be of the multi-stage constitution. When necessary, it is possible to arrange a connection module to connect the respective modules.

Further, the finisher (after-processing device) module may be connected after the output module 7. Examples of the finisher module are: a module having a stapler in which sheets of paper are stacked and one portion or two or more portions on the corner of the stacked sheets are stapled by the stapler; and a module having a punching mechanism by which punch holes for filing are formed. It is preferable that the finisher module can be used even in the state of off-line in which the finisher module is disconnected from the user interface device 8.

In the image forming apparatus 1, each module can be freely replaced with another one. Especially, in the image forming apparatus 1 of this embodiment, IOT module 2 and the exit module 7 are differently composed. Therefore, in the case where the processing speed and performance are enhanced and the function is multiplied, only one of them may be replaced.

DFE device is provided with a front end processor section. DFE device and the image forming apparatus 1 are connected with each other by DDI (Direct Digital Interface) which is an independent interface. The front end processor section converts data of a client into raster data (RIP processing) by ROP (Raster Operation) conducted by the front engine. The front end processor section has a function of compressing the thus converted raster image. In addition to that, the front end processor section has a function of a printer controller fulfilling the printing control function depending on the image forming apparatus 1. In DFE device, DDI board used for the interface with the image forming apparatus 1 is mounted, and ROP processor and the printer controller section are arranged on this board.

RIP processing and compressing processing can be conducted at high speed in accordance with the high speed processing conducted by IOT module 2. For example, since CPU of high speed and high performance is mounted, the printer controller, which is provided in DFE device, can generate high speed data by which the print engine speed can be effectively utilized. Therefore, it becomes possible to conduct high speed full color printing in which the total productivity from giving a command of printing to conducting printing operation can be enhanced. For example, it is possible to realize a color printing system capable of printing not less than 100 sheets/minute.

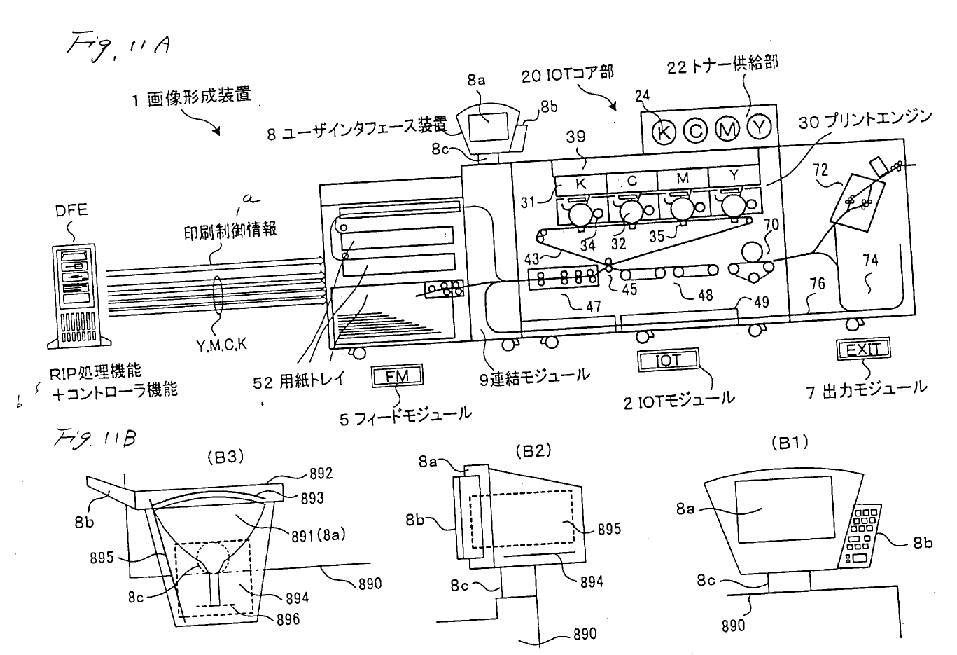

The user interface device 8 includes an input device such as a keyboard 81 and mouse 82. The user interface device 8 includes GUI (Graphic User Interface) section 80 into which a command of a user is inputted while an image is being displayed on the display of CRT 84 to the user. In the main body 83 of the user interface device 8, there is provided Sys (system controller) 85 having an interface function of connecting each module of the image forming apparatus 1 with DFE device and also having a control function. The boards used for the user interface device 8 such as a board 894 for monitor control and the electric power source, which is provided in the conventional device shown in FIG. 11, and the engine board 895 are accommodated in the main body 83.

Different from the conventional device shown in FIG. 11, this interface device 8 is directly mounted on the device body (connecting module 9 in this embodiment). The functions of the soft buttons displayed on the image plane on the touch panel of the conventional device and the functions of the hard control panel 8b are replaced with the keyboard 81 and the mouse 82. Of course, in this embodiment, the touch panel may be combined with the display face of the user interface device 8.

Control software for operating the image forming apparatus 1 is incorporated into the user interface 8. This user interface 8 is connected with DFE device having a function of image processing. For example, the user interface 8 receives printing data subjected to RIP (Raster Image Process) and also receives printing control information such as a number of printing sheets and a size of the printing sheets from DFE device. Then, the user interface 8 makes the image forming apparatus 1 carry out the required printing processing.

Concerning the printing data, there are provided four pieces of printing data including pieces of printing data of yellow (Y), cyan (C) and magenta (M), which are basic colors of color printing, and black (K), that is, there are provided four pieces of printing data of four colors of Y, M, C and K. In addition to the above four colors, the fifth color component, for example, gray (G) may be included.

Control software of the user interface device 8 receives printing control information (printing command), which is sent from DFE device, via the interface section in the image forming apparatus 1 and controls printing operation of the image forming apparatus 1 via Sys section under the control of DFE device. In the case of outputting a plurality of number of copies by the setting of collation and also in the case of reprinting in which one more copy is required after printing is completed, outputting can be effectively conducted at high speed by utilizing data held in DFE device which is subjected to RIP processing.

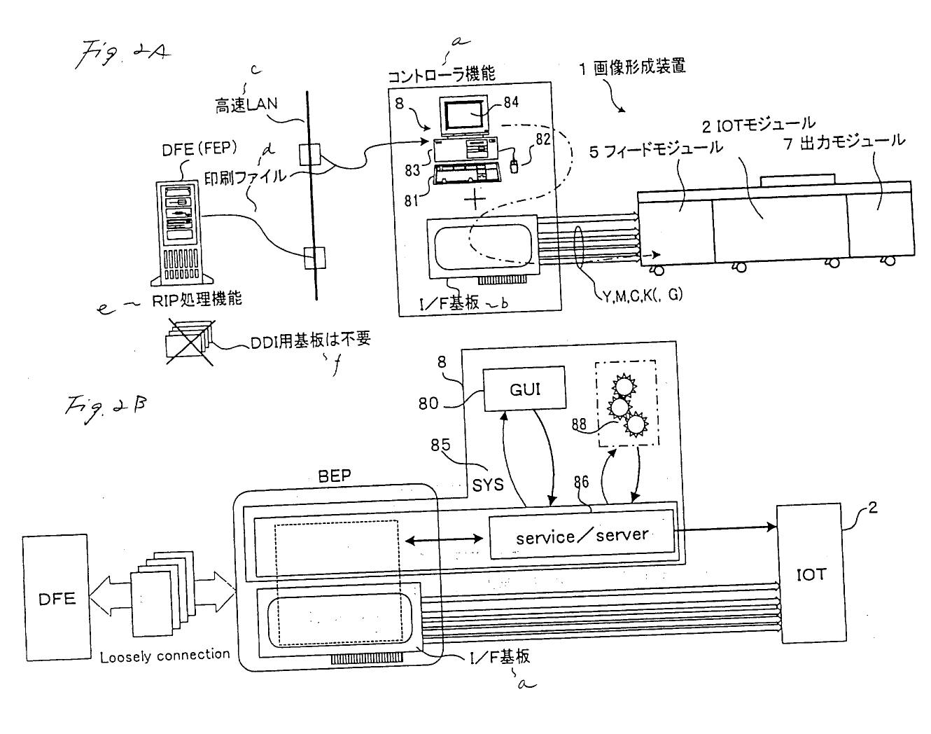

FIG. 2 is a view showing the second embodiment of the image forming system provided with one embodiment of the image forming apparatus of the present invention. In this case, FIG. 2A is a view showing an outline of the system constitution, and FIG. 2B is a view showing an example of connection with respect to the detail of the user interface device.

The second embodiment is different from the first embodiment shown in FIG. 1 at the following points. The board for DDI provided for the front end processor FEP is removed from DFE device; the user interface device 8 fulfills a control function of the processing relying on the image forming apparatus 1 in the user interface device 8 (especially, the processing relying on the engine characteristic); and the interface board with IOT core section 20, field modules 5, 6 or output module 7 is arranged between the user interface device 8 and the image forming apparatus 1. The front end processor FEP section of DFE device is not provided with a printer controller function fulfilling the printing control function relying on the image forming apparatus 1. The front end processor FEP section of DFE device mainly conducts RIP processing.

Between DFE device and the user interface device 8 and also between DFE device and IOT core section 20, transmission of an electric signal between the respective function module circuits is conducted by the optical transmission medium.

The printer controller functional portion fulfilling a control function of the processing relying on the image forming apparatus 1 of the user interface device 8 in the above structure and the portion relating to the connection interface are totally referred to as a back end processor BEP section. As a result, the user interface device 8 in the constitution of the second embodiment includes: GUI section 80 of the first embodiment; and a printer controller functional portion such as IOT core section 20 for controlling according to the engine characteristic.

In DFE device, code data generated by a client is formed into raster data by RIP processing conducted on the front engine side and subjected to compression processing. The front end processor FEP section on the DFE device side is relatively loosely related to IOT core section 20, that is, the front end processor FEP section on the DFE device side can be almost independently operated. Therefore, an electric signal is transmitted between the front end processor FEP section and the back end processor BEP section by a loose coupling on the general-use network.

For example, as shown in FIG. 2A, DFE device and the back end processor BEP section may be connected with each other by LAN (Local Area Network) conducted by the general-use correspondence protocol, the correspondence speed of which is approximately 1 GBPS (Giga Bit Per Sec). The printing file is transmitted from the front end processor FEP section to the back end processor BEP section, for example, by FTP (File Transfer Protocol).

On the other hand, transmission of an electric signal between the back end processor BEP section and IOT core section 20, which is an example of the image recording section, is relatively closely related to IOT core section 20. That is, the transmission system is composed of a correspondence interface relying on the print engine 30 which is an image recording section. For example, it is connected by an exclusive correspondence protocol.

Printing file data containing a raster base image, which is subjected to RIP processing, is sent from DFE device to the back end processor BEP section. Printing file data contains image file data of the raster base of TIFF (Tagged Image File Format). Further, printing file data contains printing control information such as a number of copies, two sides or one side, color or black and white, synthesized printing, sorted or not sorted, and stapled or not stapled.

In the back end processor BEP section, there is provided a controller for generating a command code (Command Code) according to printing control information received from DFE device and controlling the processing time of each section in the image forming apparatus 1 according to the engine characteristic. The back end processor BEP section sends image data to IOT module 2 after spool processing is completed so that it can be fitted to the engine characteristic of IOT module 2, field modules 5, 6 or output module 7. The back end processor BEP section conducts control processing relying on the engine characteristic. Further, the back end processor BEP section automatically conducts recovery processing relying on the engine characteristic such as recovering a printing sheet jam.

For example, a command given by a client is judged by the front end processor FEP section. Without relying on each section in the image forming apparatus 1 such as IOT core section 20, fuser 70 or finisher section, the command capable of being processed only by the front end processor FEP section is exclusively processed by the front end processor FEP section. In the case of processing to be conducted by the back end processor BEP section, which relies on each section of the image forming apparatus 1, the command is made to pass through onto the back end processor BEP section side.

For example, processing relating to RIP processing such as rotation, page allotment to one sheet of printing paper (N-UP), repeating processing, size adjustment of sheet of printing paper, CMS (Color Management System) for correcting a difference between devices, resolution conversion, contrast adjustment or designation of a ratio of compression (low, middle and high) is conducted by the front end processor FEP section, and the control command is not notified to the back end processor BEP section (not notified).

On the other hand, concerning the processing strongly related to the processing characteristic of the image forming apparatus 1 (processing relying on IOT) such as collation, two-side printing, processing for positioning related to the finisher device such as stamping, punching and stapling and also related to the sheet tray, adjustment of the discharged face (surface and reverse face), calibration processing such as gray balance and correction of color displacement and screen designation processing, the control command is made to pass through the front end processor FEP section and processed by the back end processor BEP section.

In this connection, the adjustment of the sheet size may be processed not only by the front end processor FEP section but also by the back end processor BEP section.

As described above, in the second embodiment, image data is file-transferred onto the user inter face device 8 side, for example, by FTP (File Transfer Protocol) as compressed data of Tiff. That is, on the front end processor FEP section side, one job is one-sidedly transferred to the back end processor BEP section side in the order of RIP processing without relying on the engine characteristic. Then, pages of the job are rearranged on the back end processor BEP section side so that the pages can be appropriately printed.

According to the constitution of the second embodiment, DFE device can be released from the complicated processing corresponding to the engine characteristic. Therefore, when a common personal computer PC is used as DFE device and software is installed in this personal computer, the this personal computer can fulfill the function of the front end processor FEP section.

In addition to that, the back end processor BEP section side, which is in charge of the complicated processing corresponding to the engine characteristic, can be released from RIP processing. Accordingly, control can be flexibly changed corresponding to the performance of IOT module 2.

Due to the foregoing, even when the front end processor FEP section side is not familiar with the engine characteristic or know-how, it is possible to easily provide a printer controller to the engine which is required to be a target on business.

Since the front end processor FEP section does not rely on the print engine 30, even when a user purchases a new print engine, it is possible to use the conventional front end. Further, it is possible to connect it with a front end manufactured by other makers. In other words, it is possible to use a commonly used printing RIP engine and a RIP engine manufactured by other makers.

Since a command necessary for the front end processor FEP section is processed by the front end processor FEP section and a command necessary for the back end processor BEP section is immediately notified to the back end processor BEP section side while conducting RIP processing, the productivity can be enhanced. Before the completion of RIP processing with respect to all pages in the job, pages capable of being printed by the image forming apparatus 1 are immediately processed without having a waiting time. Therefore, even a client wants any form of output, the image forming apparatus 1 can be operated by its high speed performance.

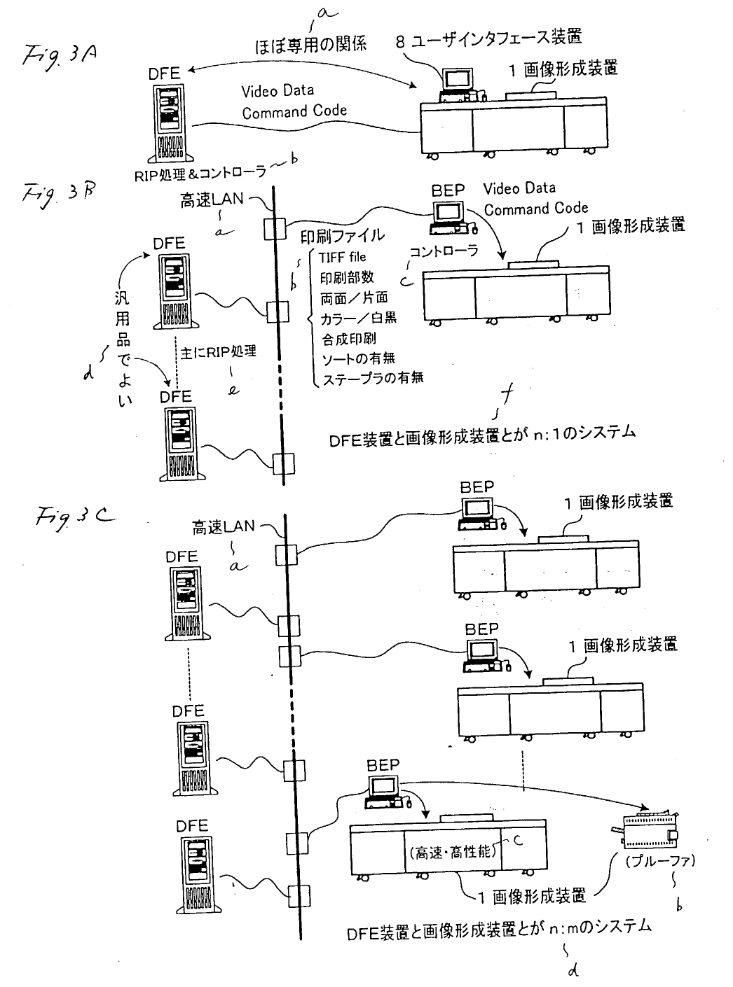

FIG. 3 is a view showing a difference between the image forming system of the first embodiment and the image forming system of the second embodiment. In this case, FIG. 3A is a view showing a system arrangement of the first embodiment, and FIGS. 3B and 3C are views showing a system arrangement of the second embodiment.

In the example of the connection of the first embodiment, image data (video data), which is subjected to RIP processing in accordance with the characteristic of the image forming apparatus 1, is sent from DFE device to IOT module 2. When the processing speed of the image forming apparatus 1 is increased, the higher the processing speed is increased, the more difficult it becomes to control the processing time of each section in the image forming apparatus 1 by the controller on the DFE device side. Therefore, as shown in FIG. 3A, it is inevitable to adopt the arrangement in which DFE device and the image forming apparatus 1 are closely related to each other and an exclusive DFE device is used according to the individual image forming apparatus 1.

For example, in the case of raster development (RIP processing) or control of the printing unit, DFE device of the high functional model uses a standard controller having a high controlling property, the image quality of which is high. Unless the front end processor FEP section side is especially familiar with the characteristic and know-how of the engine, it is impossible to control the image forming apparatus 1 of high speed and high performance. The higher the processing speed is increased and the higher the function is enhanced, the more difficult it becomes to control the image forming apparatus 1. Therefore, in the constitution of the first embodiment, it is necessary to provide DFE device having an exclusive processing function agreeing with the image forming apparatus 1. For the above reasons, it is difficult to build a system in which one set of image forming apparatus receives a demand of printing from a plurality of DFE devices.

For example, when a highly functional system, the processing speed of which is high, wants to be realized, there is nothing but to adopt the method in which the control method of the image forming apparatus 1 is previously notified to the standard controller and controlling operation is conducted under the control of the standard controller. However, it is difficult to control the image forming operation of the highly functional image forming apparatus 1 of high processing speed by the conventional controller or commonly used controller. For example, in the process of continuous operation, it is more difficult to decide the start time of the next sheet (sheet of printing paper), that is, controlling becomes more difficult. Especially, in the case of two-sided printing, it is necessary to interrupt a continuous transport process of printing a surface of one sheet so that a process of printing a reverse face of the other sheet can be squeezed. The higher the processing speed is, the more difficult the control becomes.

On the other hand, in the constitution of the second embodiment, DFE device side (to be specific, the front end processor FEP section) is mainly in charge of RIP processing function, and the user interface device 8 (to be specific, the back end processor BEP section) is in charge of the printer controller function. Therefore, the image data for forming an image and the image forming condition (number of copies, one side or two sides, color, and sorted or not sorted) are received by the back end processor BEP section, and the back end processor BEP section can control the image forming operation of the device concerned according to the performance and characteristic of the print engine.

Different from the conventional DFE device, the back end processor BEP section is not restricted by the use of the standard controller. Therefore, control of image formation conducted by this back end processor BEP section is provided with high speed and extendability compared with DFE device. Accordingly, compared with the constitution of the first embodiment, the processing speed and the function of this embodiment can be easily enhanced.

In the constitution of the second embodiment, RIP processing is conducted by the front end processor FEP section of DFE device, and pages can be rearranged agreeing with the image forming apparatus 1 by the back end processor BEP section. DFE device (to be specific, the front end processor FEP section) and the image forming apparatus 1 (to be specific, the print engine) may be loosely connected with each other. In other words, the front end processor FEP section and the print engine may be loosely related with each other. Concerning the processing conducted by DFE device, it may be restricted in the range of RIP processing which is not affected by the performance of the image forming apparatus 1.

Due to the foregoing, a load of processing to be given to DFE device is decreased. Therefore, it is possible to use DFE device provided with a commonly used controller capable of processing at high speed. Accordingly, the total system cost can be reduced. In addition to that, since the commonly used DFE device can be used, as shown in FIG. 3B, it is possible to build a system in which one set of image forming apparatus 1 receives a demand of printing from a plurality of DFE devices, that is, it is possible to build a system in which a ratio of the number of DFE devices to the number of image forming apparatus is n:1.

Further, as shown in FIG. 3C, it is possible to build a system in which a plurality of image forming apparatus 1 are connected, that is, it is possible to build a system in which a ratio of the number of DFE devices to the number of image forming apparatus is n:m. In this case, it is possible to build a system in which two types of image forming apparatus 1 such as an image forming apparatus 1 of high speed and high performance and a proofer (an example of the image forming apparatus 1) for confirming an output are arranged in parallel. Alternatively, it is possible to build a system in which two types of image forming apparatus 1 are arranged in tandem and processing is conducted in series.

In the system of proofer connection, it is possible to build DDCP (Digital Direct Color Proofing) system in which before the image forming apparatus 1 of high speed and high function directly conducts printing, the outputting of color proofreading is directly conducted from DTP data by the proofer. For example, when the back end processor BEP section receives proof data so that it can be used as a printing job, image data, the data type of which is suitable for proofing (for example, a low video rate), is outputted to the proofer, so that a command of output for color proofreading is given. On the other hand, when a normal printing job is received, image data of a high video rate is outputted into the machine of high speed and high function, so that a command of printing of high speed and high function is given.

In the system shown in FIG. 3C, it is preferable to mount CMS (Color Management System) in which a minute difference (difference in devices) of color output between the machine of high speed and high function and the proofer or between the machine of high speed and high function and the machine connected in tandem is connected.

When the system is composed as described above, the rate of the number of machines of which is n:1 or n:m, it becomes possible to select an image forming apparatus so that a load given to the apparatus can be balanced and also it becomes possible to select an image forming apparatus suitable for a job of printing. Accordingly, the output can be effectively processed.

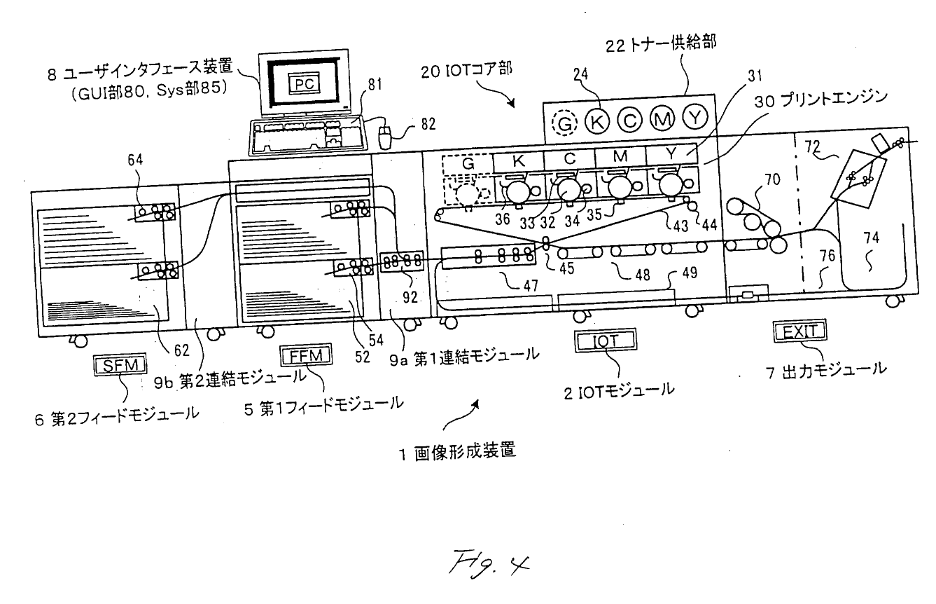

FIG. 4 is an overall arrangement view showing an outline of the image forming apparatus of the present invention. This image forming apparatus 1 includes: IOT module 2; a first feed module (FFM; First Feeder Module) 5; a second feed module (SFM; Second Feeder Module) 6; an output module 7; and a user interface device 8.

IOT module 2 and the first feed module 5 are connected with each other by the first connecting module 9a. The first feed module 5 and the second feed module 6 are connected with each other by the second connecting module 9b. IOT module 2 and the output module 7 are directly connected with each other.

It is needed to enhance the performance and processing speed of an image forming apparatus. However, in the case where the number of colors to be processed by the print engine is five or more, the structure of the fusing unit becomes complicated and further the size is increased. Therefore, it becomes difficult to accommodate the print engine and the fusing section in the same IOT module.

Therefore, in the image forming apparatus 1 of this embodiment, IOT module 2, two feed modules 5, 6 and output module 7 are respectively made into different units, and even if the feed modules and the fusing section are changed, a change in the main body (IOT module 2) is minimized, so that extendability can be enhanced. In this connection, as shown by a one-dotted chain line at the center of the output module 7 in the drawing, the output module 7 may be further divided into a fusing module and sheet discharge module.

In the first module 5 and the second module 6, there are respectively provided groups of pickup rollers 54, 64 for drawing out sheets of printing paper from the respective sheet trays 52, 62. In the first connecting module 9a, there are provided a group of transport rollers 92 for delivering sheets of printing paper IOT, which are transported from the first feed module 5 and the second feed module 6, to the transport path of the IOT module 2.

The exit module 7 includes: a fuser 70 for fusing an image which is transferred onto a sheet of printing paper by IOT module 2; a sheet discharge device 72 for discharging a sheet of printing paper onto which an image is transferred; a discharge sheet tray 74 in which a sheet of printing paper, onto which an image is printed, is temporarily preserved without discharging the printed sheet of paper outside the apparatus; and a reversal path 76 for reversing a printed sheet of paper to IOT module 2. The fuser 70 can be driven at high speed in accordance with the high speed processing conducted by IOT module 2.

The sheet discharge processing device 72 may be provided with a finisher function such as a simple stapling function. Even in the off-line state in which this sheet discharge device 72 is disconnected from the user interface device 8, this sheet discharge processing device 72 can be operated.

IOT module 2 includes: IOT core section 20; and a toner supplier 22. In the toner supplier 22, the toner cartridges 24 of Y, M, C and K for color printing, which are a standard set of toner cartridges, are mounted. In addition to the above four colors, the toner cartridge 24 of gray G, which is the fifth color component, can be mounted in the toner supplier 22.

In IOT core section 20, the print engines (printing units) 30 for the respective colors corresponding to the above color components are arranged in line in the sheet transport direction, that is, the print engines 30 are arranged in tandem. The developing unit 34 of each print engine 30 is supplied with toner (colored powder), which is a developing agent, from the toner cartridge 24 via a supply path not shown, for example, via a reserve tank.

An order of the arrangement of the print engines 30, the colors of which correspond to the colors of color materials, is determined according to a relation of dark decay with the characteristic of each toner or according to an influence given by black toner to toners of other colors in the case where the toners are mixed with the black toner. Only an example is shown in the drawing.

The toner cartridge 24 and the photoreceptor drum 32 are detachably arranged in the apparatus body. In this connection, in order to take stronger countermeasures against illegal products than the conventional well known system, electric signals are transmitted between the toner cartridge 24 and the main body by an optical member which transmits and receives laser beams or infrared rays by detachably connection.

In general, it is more difficult to get optical transmission parts than circuit parts to utilize electric waves. Further, it is more expensive to get optical transmission parts than circuit parts to utilize electric waves. Therefore, it is more difficult to mount the optical transmission parts than the electric parts, in which electric waves are utilized, described in the method of preventing illegal products (for example, described in the U.S. Pat. No. 6,181,885). This tendency is especially strong in the case of parts such as a semiconductor laser in which laser beams are utilized.

Accordingly, as a countermeasure to prevent illegal products, this method in which the optical means is utilized is stronger than the method in which electric waves are utilized. Since components are detachably connected with each other, the toner cartridges 24 and others can be easily attached to the main body. In the countermeasure of preventing illegal products in which the technique of electric waves is utilized, the problems of EMI (Electro Magnetic Interference) and EME (Electro Magnetic Emission) can be caused. However, in the case of optical transmission, such problems are not caused.

IOT core section 20 includes: an intermediate transfer belt 43; a secondary transfer section 45; a first transport path 47 for transporting a sheet of printing paper to the transfer section 45 and having a positioning function (Regi/Aligner); a second transport path 48 for transporting a printed sheet of printing paper, which passes through the secondary transfer section 45, to the exit module 7; and a reversal transport path 49 for transporting a sheet of printing paper, on one side of which printing is conducted, which is inverted by the exit module 7 after one side printing, to the transport path 50. The first transport path 47 is provided with a positioning function (Regi/Aligner).

In the periphery of the intermediate transfer belt 43 on the front stream side in the transport direction of the belt of the print engine 30 composed in tandem (in the drawing, on the right of the print engine 30 for yellow), there is provided a cleaner 44 for cleaning an image transferred onto the intermediate transfer belt 43.

This IOT core section 20 is provided with a high speed motor, by which printing operation can be conducted at a higher speed than the motor used for the conventional image forming apparatus 1. Further, IOT core section 20 can be driven at high speed in which clocks of high frequencies are used so as to drive the inner circuit.

In the same manner as that of the print engine used as a printing functional portion of a printer or copier, the print engine 30 provided in IOT core section 20 is a printing engine (marking engine) of ROS (Raster Output Scanner) base having various components used for the optical scanner device 31, the photoreceptor drum 32 and the electrophotographic process. This print engine can be driven at high speed corresponding to the circuit to be driven at high speed.

The optical scanning device 31 is operated as follows. A laser beam emitted from a semiconductor laser not shown is reflected and deflected by a polygonal mirror not shown toward the photoreceptor drum 32 which is an example of the photosensitive component. The laser beam modulated by image information is sent onto the photoreceptor drum 32 passing through a group of lenses, so that an image can be formed on the face of the photoreceptor drum 32 to be scanned.

In the process of image formation, first, the photoreceptor drum 32, which is rotated at a constant speed, is electrically charged by the charging unit 33 to a predetermined polarity and voltage. Next, sheets of printing paper are drawn out one by one from the sheet trays 52, 62 by the group of pickup rollers 54, 64 at a predetermined time and fed to the secondary transfer section 45 via the connecting module 9a and the first transport path 47.

When a forward end portion of the sheet of printing paper is detected by a forward end detector not shown, in the optical scanning device 31, a laser beam modulated by an image signal (for example, 8 bits of each pixel and each color component) is emitted from the semiconductor laser and reflected on the polygonal mirror. After that, the laser beam is guided onto the photoreceptor drum 32 via the group of lenses, and scanning is conducted on the photoreceptor drum 32.

On the other hand, a signal sent from the forward end detector is outputted as a vertical synchronizing signal to a record controller (not shown) for controlling the optical scanning device 31. When the main scanning detector detects a laser beam, a beam detect signal, which becomes a horizontal synchronizing signal, is outputted to the record controller. Then, the image signal is synchronized with the beam detecting signal and successively sent out to the semiconductor laser.

Due to the foregoing, a laser beam reflected and deflected by the polygonal mirror of the optical scanning device 31 conducts scanning on the photoreceptor drum 32, which is electrically charged by the primary charging unit 33, via the group of lenses. In this way, an image portion or a background portion on the photoreceptor drum 32 is selectively exposed to the laser beam, and an electrostatic latent image is formed on the photoreceptor drum 32.

This electrostatic latent image is changed into a visible toner image by the developing devices 34 to which toners of the colors of Y, M, C or G are supplied. This toner image is absorbed onto the intermediate transfer belt 43 by the primary transfer unit 35 and successively transferred in the multiple way. After the primary transfer is completed, toner remaining on the photoreceptor drum 32 is recovered from the surface of the photoreceptor drum 32 by the cleaner 36.

After that, the image (toner image) transferred onto the intermediate transfer belt 43 is transferred onto a sheet of paper transported from the first field module 5 and the second field module 6 via the first connecting module 9a and further transported to the exit module 7 by the second transport path 48. Then, the toner image is fused onto the sheet of paper by the fuser 70 arranged in the exit module 7. After that, the sheet of paper is temporarily held in the discharge sheet tray 74 or immediately delivered to the discharge sheet processing unit 72. When necessary, the sheet of paper is subjected to a predetermined final processing and then discharged outside the apparatus. In the case of printing on two sides, a printed sheet of paper is drawn out from the discharge sheet tray 74 to the reversal path 76 and delivered to the reversal path 49 of IOT module 2.

IOT core section 20 shown in FIG. 4 is of the one belt type intermediate belt system IBT in which one intermediate transfer belt 43 is provided. However, the present embodiment is not limited to the above system, for example, IOT core section 20 may be of the two belt system in which two intermediate transfer belts 43 are provided. Alternatively, IOT core section 20 may be of the system in which no intermediate transfer body is provided and a toner image on the photoreceptor drum 32 is directly transferred onto a sheet of printing paper.

In the case of employing IBT system, it is necessary to give consideration to the advantages and disadvantages of one belt and two belts when the apparatus is designed. For example, the one belt system is advantageous in that: the belt driving can be easily controlled; and the deterioration of quality of an image is seldom caused. However, the one belt system is disadvantageous in that: the belt length is large (For example, the belt length is about 4 m.); it takes labor to replace the long belt (For example, two workers are required for replacing the belt); the maximum unit width is large (For example, the maximum unit width is about 2 m.); it becomes difficult to handle the apparatus; and module rigidity is required for the belt.

On the other hand, the two belt system is advantageous in that: the belt length is small (For example, the belt length is about 2 m.), so that the belts can be relatively easily replaced and the extendability is high; and the maximum unit width is small (For example, the maximum unit width is about 1 m.). However, the two belt system is disadvantageous in that: there is a possibility that the image quality is deteriorated; alignment control of two belts is required; the apparatus height is increased (For example, the apparatus height is about 1 m.); and the running cost is raised because the number of belts is two.

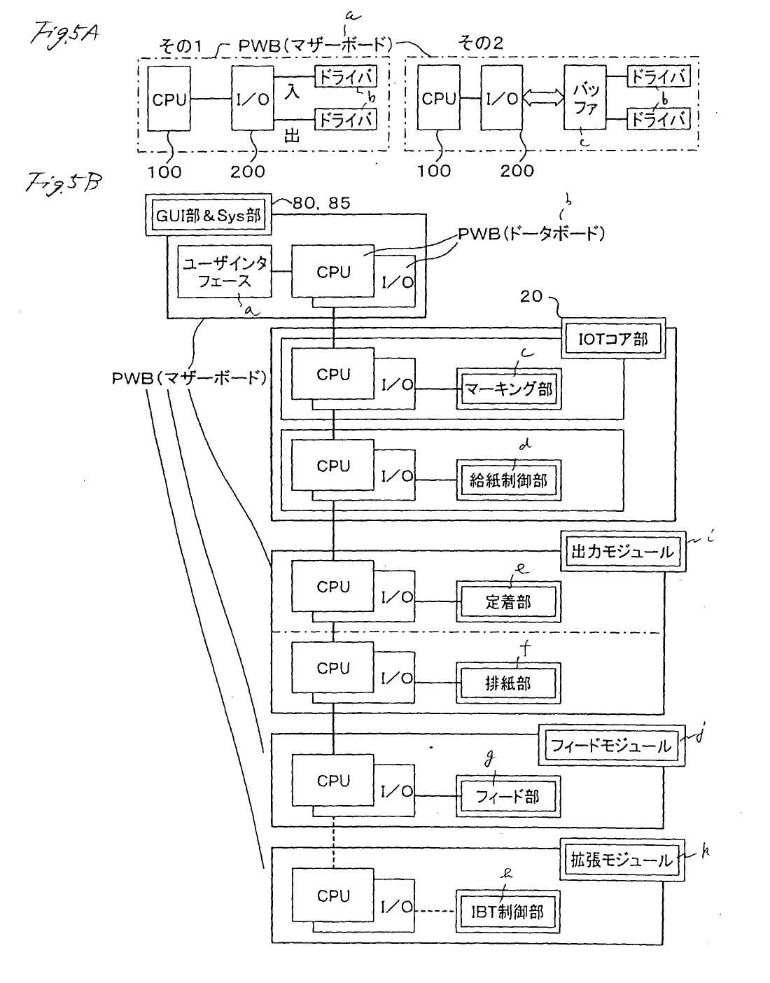

FIG. 5 is a view showing an example of the arrangement of the circuit module of the image forming apparatus 1 shown in FIG. 4. FIG. 5A is a view for explaining a primary portion relating to the circuit module, and FIG. 5B is a view showing a specific example of the arrangement of the image forming apparatus 1 to which FIG. 5A is applied.

As explained in FIG. 4, the image forming apparatus 1 of the present invention is characterized as follows. The modules are respectively made into different units. Therefore, even when the modules arranged in the periphery of the main body (IOT module 2) such as a feed module and a fusing section are changed, a change in the main body is minimized, so that the extendability can be enhanced. In accordance with that, concerning the circuit structure, when the board PWB is divided corresponding to each module, the extendability can be enhanced.

Therefore, as shown in FIG. 5A, each board PWB includes: CPU (Central Processing Unit) 100 having a main information processing function and calculating function in each section on the board; and I/O section 200 which is an input and output interface portion for driving a functional operating section, which will be referred to as a device hereinafter, operated according to an exclusive functional portion of each module such as a circuit section in each module and motor. CPU 100 and I/O section 200 are the minimum components of the circuit module.

CPU 100 is composed of a logic circuit (Hardware Logic), the processing contents of which can be renewed by software, such as FPGA (Field Programmable Gate Array) and DSP (Digital Signal Processor). As the peripheral parts of CPU 100, there are provided a volatile semiconductor memory such as RAM (Random Access Memory), ROM (Read Only Memory) and memory controller. Therefore, it is possible to conduct reprogramming of printing processing and input and output processing in the image forming apparatus 1. Due to the above constitution, it is possible to flexibly cope with the correction of bugs existing in software. Further, even when a module different from the previously expected image forming apparatus 1 is connected with IOT module 2 for the objects of increasing the processing speed, enhancing the performance and multiplying the function, the apparatus can flexibly cope with the change.

CPU 100 incorporated onto each board can control other circuits by the common OS (Operating System). Therefore, CPU 100 functions as an operating system section into which a substantially common software architecture, which is common among other circuit boards, is incorporated. I/O section 200 is capable of controlling a device driver for driving a device corresponding to an exclusive functional portion of the module in the common operating system. In addition to that, CPU 100 and I/O section 200 are mounted on an exclusive mother board of each module as a daughter board. In this connection, CPU 100 and I/O section 200 may be mounted on a common daughter board. Alternatively, CPU 100 and I/O section 200 may be mounted on different daughter boards.

Due to the foregoing, the software module composed of CPU 100 and I/O section 200 can be made common, and only one type of software module board PWB may be prepared as spare parts. In the case where CPU 100 and I/O section 200 are respectively provided as individual daughter boards, CPU 100 and I/O section 200 must be respectively prepared. When software is renewed with respect to CPU board, only a processing software module suitable for each module may be installed. When software is downloaded to FPGA, software (OS and application software) can be changed and further I/O mapping can be changed with respect to the same software module board. One type software module board can be used for any module or anywhere in the module, and further the number of the modules to which software is applied can be freely changed. When the circuit boards are replaced or the number of the circuit boards is changed as described above, it becomes possible to realize an image forming apparatus 1, the extendability of which is high.

In this connection, concerning the connection form between CPU 100 and the device and also between I/O section 200 and device, there are provided two forms. One is a form shown in item (1) in FIG. 5A in which CPU 100 is connected with the input device and output device via I/O section 200. The other is a form shown in item (2) in FIG. 5A in which I/O section 200 is connected with the input device and output device via a buffer. In either connection form, CPU 100 can be connected with devices of two or more systems. In addition to that, it is possible to freely set a relation of the master and slave of devices of two or more systems. Further, even between the boards, it is possible to freely set a relation of the master and slave.

In the image forming apparatus 1 shown in FIG. 4, in order to optimize the apparatus as an individual product and further in order to enhance the extendability of the modules, the circuit module is provided for each module. Further, the technique (CPU 100+I/O section 200+Device Structure) shown in FIG. 5A is applied to circuit module boards, so that the number of the circuit module boards can be increased and decreased. The exclusive board PWB is mounted on each functional section, CPU 100 or I/O section 200, and the individual board is detachably attached onto the mother board. When the above system is employed in which the number of the circuit boards is increased and decreased, it is possible to realize an image forming apparatus 1, the extendability of which can be enhanced.

For example, as shown in FIG. 5B, GUI and Sys section are prepared on the user interface device 8 side, and the daughter board PWB is provided on which the user interface circuit, CPU 100 and I/O section 200 are mounted. In IOT core section 20, there are provided a marking section MK relating to the printing processing, a daughter board PWB on which CPU 100 and I/O section 200 for controlling the marking section MK are mounted, a sheet feed controller PH for controlling the feed modules 5, 6, and a daughter board PWB on which CPU 100 and I/O section 200 for controlling the sheet feed controller PH are mounted. In the exit module 7, there is provided a daughter board PWB for the fusing section to control the fuser and for CPU 100 and I/O section 200 to control the fusing section, and also there is provided a daughter board PWB for the discharge sheet section (EXIT) to process a discharge sheet and for CPU 100 and I/O section 200 to control the discharge sheet section (EXIT). In the feed module 5, 6, there is provided a daughter board PWB for the feeder section to drive the feed motor and for CPU 100 and I/O section 200 to control the feeder section. Further, as a spare part, there is provided a board for the extended module. For example, there is provided IBT controller corresponding to a changeover of the intermediate transfer body system (IBT system), and also there is provided a daughter board PWB for CPU 100 and I/O section 200 for controlling the IBT controller.

As described above, in the image forming apparatus 1 of this embodiment, when the module is divided, the function can be more multiplied and further the processing speed can be more raised so that the needs can be satisfied. For example, in the image forming apparatus, the structure of four tandem is enhanced to the structure of five tandem or more. Alternatively, the processing speed of the image forming apparatus is increased to a high value of 200 sheets per minute or more. In this case, software incorporated into the individual modules must be renewed so that the bugs can be corrected and the specification of the module can be changed. It is important how to effectively renew the software.

The module of the image forming apparatus 1 of this embodiment is divided, and the image forming apparatus 1 is actually composed of multiple CPU. However, by utilizing the point that CPU on which the common OS is mounted is used, software is effectively renewed as follows.

For example, board PWB, which is formed into a module, is changed into board PWB having a different function by rewriting the application software. Due to the foregoing, the specification of the board can be simply realized. In the case where a plurality of modules must be renewed, the individual renewal programs are not sent to the individual modules but the individual renewal programs are downloaded by one module in the lump, and other modules are renewed by utilizing a common rewriting program from there. This is an advantage provided by utilizing CPU on which the common OS is mounted. That is, since the common OS (the same architecture) is used, it is possible to use the common rewriting program, and it is possible for one module to renew other modules.

In this case, it is judged to which module the renewal program is effectively downloaded, and the programs including other renewal programs may be downloaded to the effective module. Rewriting of the programs of a plurality of modules may be conducted in parallel.

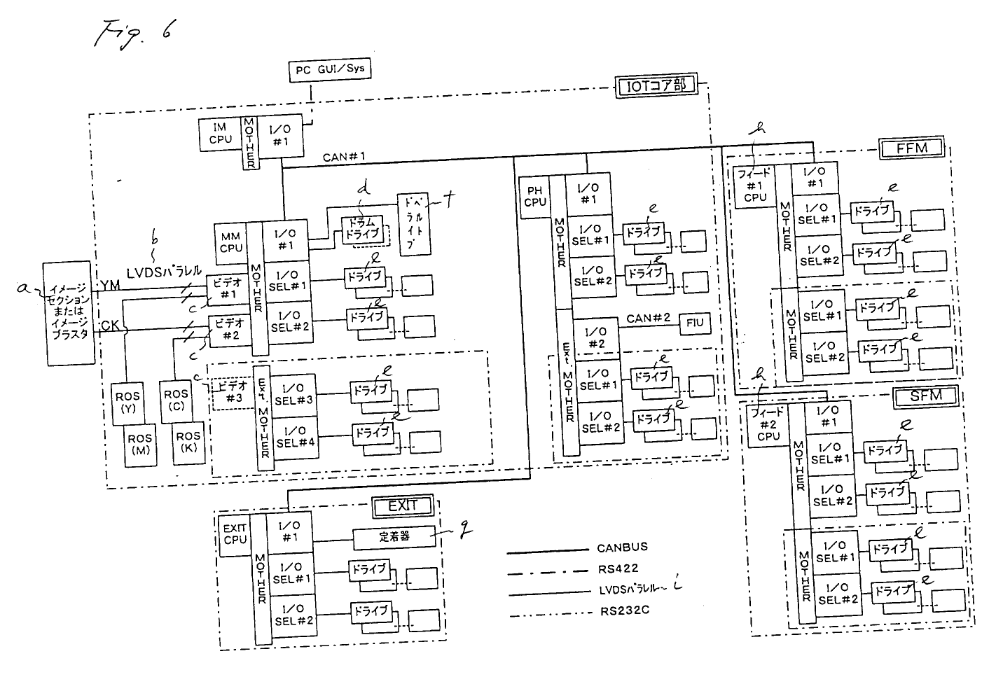

FIG. 6 is a view showing an example of a specific board constitution in the case where the circuit module combination shown in FIG. 5 is applied to the image forming apparatus 1, shown in FIG. 4. In this embodiment, boards for the circuit blocks are arranged on the mother board.

In the case where the overall circuit of the image forming apparatus 1 is composed when the circuit modules, in which CPU 100 and I/O section 200 are the minimum component as shown in FIG. 5, are combined with each other, each circuit module may be provided corresponding to the module constitution of the device. Alternatively, a plurality of circuit modules may be assembled to one compound circuit module. In the case where CPU 100 and I/O section 200 for each module are arranged on the board, CPU 100 and I/O section 200 for the same module are not necessarily mounted on the same board. For example, CPU 100 and I/O section 200 for IOT module 2 may be respectively arranged on different sub-boards, and each sub-board may be mounted on the mother board. According to the form of the combination, the connection of the physical interface and that of the logical interface are changed.

The logical interface between CPU 100 and I/O section 200 for each module may be determined by a load given to CPU 100 or I/O section 200 or by the module characteristic. For example, the exit module 7 is seldom changed after it is once installed, that is, the exit module 7 is somewhat fixed. On the other hand, the specification of the finisher module is appropriately changed according to the request of a user. When the image forming apparatus 1 is composed, except for the system in which data is processed, there is provided a diagnostic function to diagnose a state of each section in the apparatus. In this system having the diagnostic function, it is also preferable that this diagnostic system can cope with a dispersion of the load and a change in the module.

For example, the governing CPU and the governing diagnostic section to govern the entire apparatus are provided. A command of the user interface device 8 may be received by the governing CPU, and the individual CPU (module CPU) arranged in each module may be controlled. This governing CPU may not control all module CPU but control the main module CPU, and under the control of the governing CPU, some module CPU may control other module CPU (sub-module CPU). In this way, a load can be distributed. In addition to that, the governing CPU can not be affected by a change in the sub-module in which the main CPU is not arranged.

For example, the physical interface and the logical interface may be determined from the following viewpoints. First, it is aimed to provide a constitution which is not affected by a change in the constitution of the board for IOT module 2. In this embodiment, in order to realize IOT constitution, the extendability of which is high, the present embodiment employs a system in which the number of the boards is increased and decreased. In this case, it is aimed to realize a system in which a change in software is minimized, that is, it is aimed to realize a system in which a change in the interface is not caused. Due to the foregoing, software can be further made into a framework.

In order to disperse a load, IOT manager IM having the governing CPU is provided. Marking section MK (Mrk) relating to printing processing of IOT module 2 controls the image generating section, and the sheet feed controller PH (Paper Handling) controls the sheet transport system (the first feed module 5 and the second feed module 6). IOT manager IM governs them. In this form, the finisher module becomes the sheet feed controller PH system.

In order to cope with a load dispersion and module change, the diagnostic processing system (Diag) to diagnose a state of each section of the apparatus is divided into the sub-diagnostic processor (Diag (Sub)), which is a diagnostic processing system of each board, and the main diagnostic processor (Diag (Main)) which is an example of the governing diagnostic section to arrange a state of each sub-diagnostic processor except for the sub-diagnostic processor for the finisher module. Due to the foregoing, a change in the board constitution can be absorbed by the main diagnostic processor. A relation between the main diagnostic processor and the sub-diagnostic processor is formed into a pattern, so that the diagnostic processing system can be formed into a framework.

In this connection, the diagnostic processing system only conducts monitoring analog quantities (analog monitor) such as reading and writing a memory, initializing a memory, checking an input and output, a state of consumption of expendable supplies and information of the sensor. For example, the diagnostic processing system does not conduct checking whether or not other modules such as a scanner section exist in the case of utilizing this apparatus as a copier, and also the diagnostic processing system does not conduct checking whether or not operation is appropriate. The diagnostic processing function of the finisher module is conducted by the finisher module itself. Due to the foregoing, the main diagnostic processor is not changed when the finisher is changed. It is possible to use the finisher off line.

A module of an opponent of IOT manager IM is not changed. In order not to change the module of the opponent of IOT manager IM, IOT manager IM interfaces with only the marking section MK, sheet feed controller PH, main diagnostic processor and Sys section 85 of the user interface device 8. Concerning the diagnostic processing system, IOT manager IM interfaces with the main diagnostic processor, however, IOT manager IM does not interface with the sub-diagnostic processor. Due to the foregoing, even when the board constitution of the diagnostic processing system is changed, IOT manager IM is not changed at all. Due to the foregoing, the degree of abstract of IOT manager IM is enhanced, and IOT manager IM can be made into a framework.

Even when the feed module 5, 6 is changed, the sheet feed controller PH does not affect IOT manager IM, that is, IOT inside interface is not changed. Therefore, for example, the first feed module (1stFdr) 5 and the second feed module (2ndFdr) 6 interface only with the sheet feed controller PH. Due to the foregoing, IOT manager IM can be made into a framework.

It is composed so that IOT manager IM can not be affected even when the output module 7 is changed. In order to accomplish the above object, for example, the output module 7 interfaces only with the sheet feed controller PH. Due to the foregoing, a change in the output module 7 can be absorbed by the sheet feed controller PH.

From the viewpoint of the logical interface, the communication protocol is used which is suitable for reducing the harness cost, enhancing the reliability of communication between the modules and increasing the transmission speed. For example, CAN (Controller Area Network; ISO 11898) is preferably used. In the case of CAN bus in which CAN is used, it is possible to send a command all at once. In order to reduce a load given to the interface by utilizing this advantage that the command can be sent all at once, the feed module 5, 6 and the output module 7 are set on the same interface.

It is composed so that the interface of the finisher module can not be affected even when the constitution of the exit module (EXIT) 7 is changed. Alternatively, it is composed so that a load can be reduced even when the constitution of the exit module (EXIT) 7 is changed. In order to accomplish the above object, the finisher module is controlled by the sheet feed controller PH. If the output module 7 controls the finisher module, information necessary for controlling the finisher must be transferred by the route of IOT Manager IM→Sheet Feed Controller PH→Output Module 7. Therefore, a load given to the interface is heavy. On the other hand, when the finisher is controlled by the sheet feed controller PH as described above, the load given to the interface can be reduced.

The board constitution shown in FIG. 6 shows the above result. For example, on IOT module 2, there are provided a mother board for IOT manager IM, mother board (MOTHER) for the marking section MK and mother board for the sheet feed controller PH. In the same manner, in the feed module 5, 6 and the output module 7, the respective mother boards are provided.

In this connection, an extra mother board (Ext. MOTHER) is prepared so that an additional board can be attached when necessary in the case of a change in the specification. In the case of attaching a finisher module, a board module corresponding to it may be added.

On the mother board, for example, there are provided IOT manager IM, marking section MK, sheet feed controller PH, feed section, input and output board (I/O) for interface function between the primary circuit portions such as an output processor, input and output changeover board (I/OSEL) for interface function with the driver, CPU board for each module, and daughter board such as a circuit board peculiar to the module such as a video board (Video). They are mounted on the mother board via a board connector. CAN bus is used for the logical interface between the circuit modules.

Since the circuit architecture composed of a functional module circuit corresponding to the respective functional portion in the apparatus is employed, only a module circuit board for the necessary portion may be replaced when the processing speed of the system is raised, the performance of the system is enhanced and the function of the system is multiplied.

Any circuit module is provided with CPU (Central Processing Unit) 100, into which the common operation system OS is incorporated, and I/O section 200. When CPU 100 rewrites application software to be used, the function of the circuit module can be renewed. The control mechanism composed of each CPU 100 is built of a common architecture into which the common operation system OS is incorporated. Therefore, in the case of changing the specification, it is possible to effectively cope with the change in the specification. When programs in a plurality of control systems must be renewed in the case of coping with the change in the specification, by utilizing a mechanism in which the program is rewritten on the common operation system OS, the application program can be renewed more effectively and flexibly.

In this connection, the mother board and the daughter board may be connected with each other via the wire harness and the connector without using the board connector. For example, a bus transmission path of electric transmission between CPU board and the mother board or between the video board and the mother board or between the video board and the print engine (ROS) 30 may be composed of an optical transmission medium such as plastic optical fiber POF (Plastic Optical Fiber) or a sheet-shaped optical transmission bus which will be referred to as an optical sheet bus hereafter.

In this case, the optical sheet bus is an optical transmission member in which a beam of signal light is incident on an end face of a plane wave-guide having a diffusion optical system, and when the beam of signal light is diffused in the plane wave-guide, a plurality of beams of signal light are outputted from an opposing end portion. When this optical sheet bus is used, the beam of signal light is diffused at the end portion of the parallel flat plate and incident on the plane wave-guide, and the thus diffused signal light is repeatedly reflected by total reflection on the upper and lower faces in the plane wave-guide and transmitted to a large number of emergent sections opposing to the incident section.

Accordingly, different from the application of an optical fiber by which one-way communication of 1 to 1 is basically conducted, the optical sheet bus can provide the following advantages. For example, (1) A multi-cast transmission can be accomplished in which a transmission of N to N is conducted between a plurality of nodes arranged at the end portions opposing to each other of the plane wave-guide; (2) Two-way transmission can be accomplished in which a transmission can be conducted in any direction between the nodes arranged at the end portions opposing to each other of the plane wave-guide; and (3) A multi-channel transmission can be accomplished in which the transmission path is made into multiple bits laminating the plane wave-guides on each other.

The core layer of the plane wave-guide can be composed of an optical resin sheet member of 1 mm thickness made of PMMA (polymethyl methacrylate). Therefore, the core layer of the plane wave-guide can be easily joined to the light emitting and receiving element (the converter 444, 464 in the embodiment described before). For example, not an active alignment, in which mounting is conducted by monitoring an intensity of signal light which is executed when the single mode optical fiber and the light emitting and receiving element are joined or when the optical wave-guide and the light emitting and receiving element are joined, but a passive alignment, in which positioning is conducted without driving the light emitting and receiving element, can be adopted. When this passive alignment is utilized, a simple mounting suitable for reducing the cost and mass-producing can be accomplished.

When the optical transmission medium is utilized as a signal transmission interface between the boards as described above, the problems of EMI (Electro Magnetic Interference) and EME (Electro Magnetic Emission) or problems caused when the wave-form is deformed can be solved and the length of wiring can be extended. In addition to that, when the optical sheet bus is employed, the transmission speed can be enhanced and further the number of nodes can be increased.

For example, in the case of dividing the board so that the degree of freedom can be enhanced when the layout is determined, when the board is simply divided, the number of signal lines for the interface is increased, and the mounting becomes difficult. Further, since the signals run in metallic wires (for example, copper wires) at high speed, the problems of deformation of the wave-form and EMI are caused. On the other hand, when the optical transmission technique is utilized, the problems of deformation of the wave-form and EMI can be solved. Further, when the optical sheet bus is utilized, the problems caused in the process of mounting can be solved. Due to the foregoing, restrictions placed on the board arrangement can be eased.

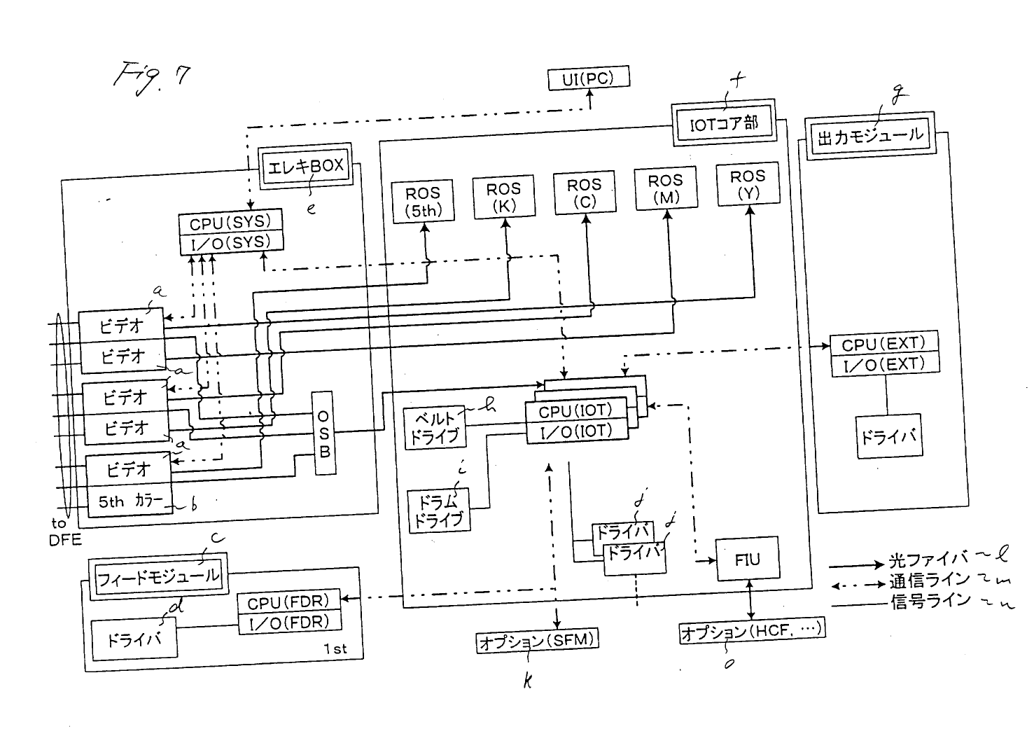

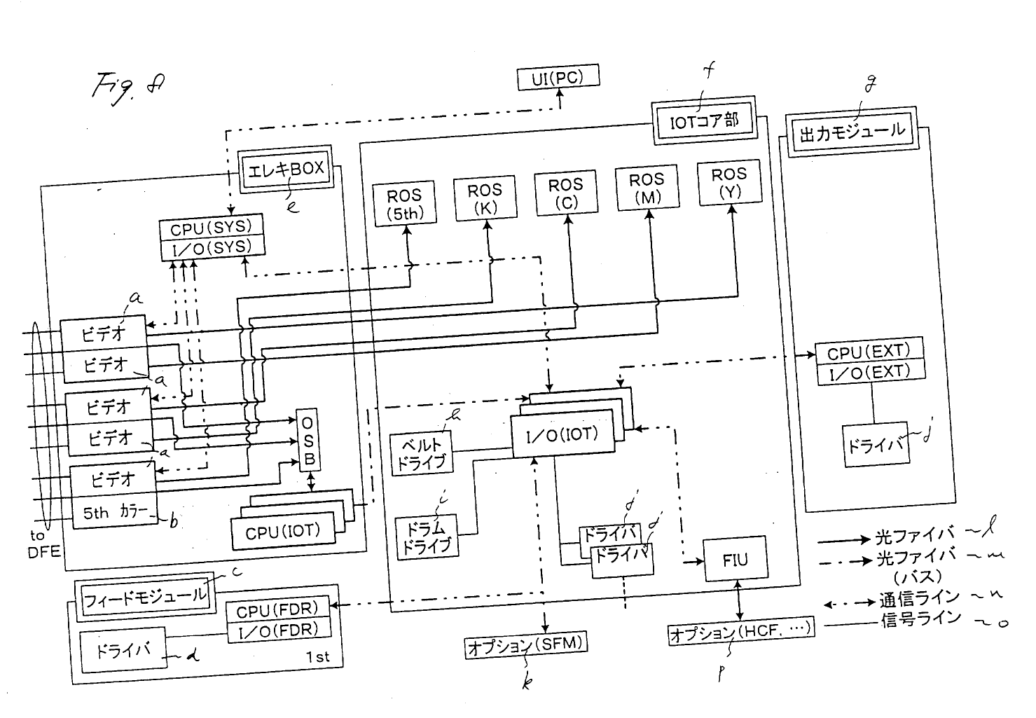

FIGS. 7 and 8 are views showing a specific example of the board arrangement in the case of employing an interface mechanism in which the optical transmission technique is utilized. CPU board and I/O board are mounted on a mother board not shown. In this connection, “SFM” for option shown in the drawing is a second field module, and “HCF” for option shown in the drawing is a high capacity feeder.

In any of the first example shown in FIG. 7 and the second example shown in FIG. 8, the optical fiber OF is utilized as the interface with the video board, and the video board is arranged distant from the mother board for IOT module 2. This video board is accommodated in the electric box (ELEC, BOX) together with CPU board and I/O board for Sys section 85.

In the first example shown in FIG. 7, the video board and the print engine (ROS) 30 are connected with each other by the normal plastic optical fiber POF (Plastic Optical Fiber), and also DFE device and the video board are also connected with each other by the normal plastic optical fiber POF as shown in FIG. 2. CPU board and the video board are connected with each other by the optical sheet bus, and also I/O board and the video board are connected with each other by the optical sheet bus. In the connection with the optical sheet bus, plastic optical fiber POF is used. In this connection shown in the drawing, the board level interconnection is adopted in which the optical sheet bus is arranged on the mother board in the electric box (ELEC. BOX). However, the optical sheet bus may be utilized for the substantially entire connection between CPU board and the video board and also between I/O board and the video board.

On the other hand, in the second example shown in FIG. 8, CPU board for IOT module 2 is arranged distant from the mother board for IOT module 2 and accommodated in the electric box (ELEC. BOX) together with the video board, CPU board for Sys section 85 and I/O board.

In the electric box (ELEC. BOX), the video board IOT and CPU board for IOT module 2 are connected with each other by the optical sheet bus. CPU board for IOT module 2 and the mother board, on which I/O board for IOT module 2 are mounted, are connected with each other by a bundle of plastic optical fiber POF (Optical Fiber Bus). In this connection, the plastic optical fiber POF is used for the connection with the optical sheet bus in the same manner as that of the first example.

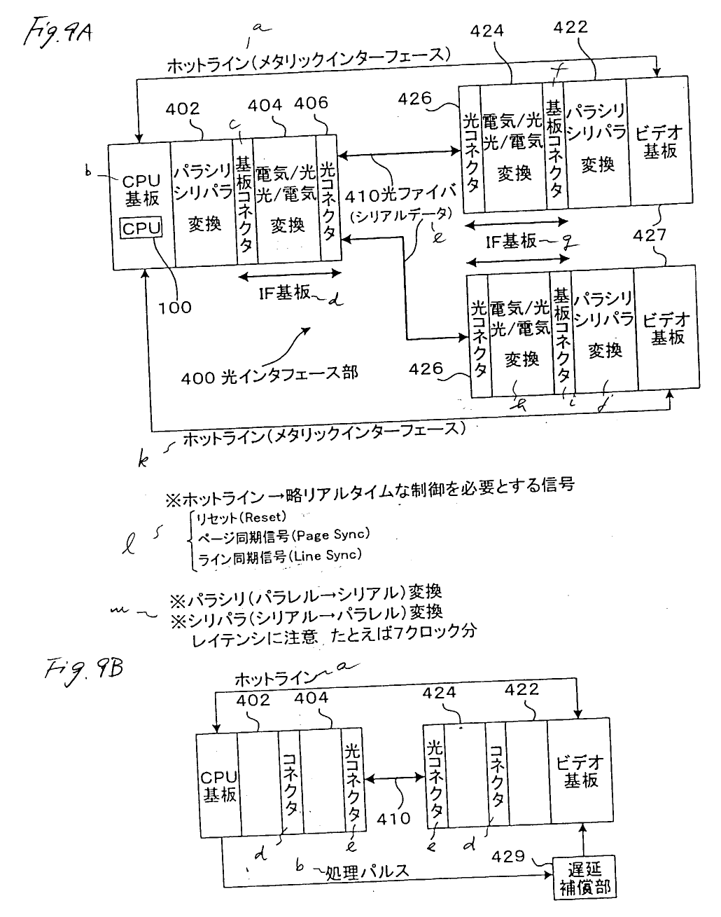

FIG. 9 is a view showing a concept of the method in which the board interface is gotten by the optical transmission medium such as an optical fiber 410. Concerning the signals such as a reset (Reset) signal, page synchronizing signal (Page Sync) and line synchronizing signal (Line Sync) which are signals requiring substantially real time control, parallel bit data is transmitted not via the optical fiber 410 but via the hot line in which the conventional metallic wires are used.

On the other hand, concerning the other control data signal not requiring substantially real time control and also concerning the video data signal or signals capable of being processed by serial data, transmission of the electric signal between the boards is gotten by the optical interface section 400 provided with the connecting interface function in which the optical fiber 410 is used. Concerning the light emitting element for the optical interface, for example, a surface light emitting type semiconductor laser (VCSEL), which emits a laser beam, is used.

In order to reduce the number of the objective transmission signal lines, the transmission signal is subjected to parallel-serial-conversion and then optically transmitted. On the light receiving side, the transmission signal is subjected to serial-parallel-conversion so that it can be returned to the original signal. In order to take countermeasures against life of the optical fiber 410 and the light source, it is composed so that each component can be easily replaced with a new one. Therefore, the optical fiber 410 and the circuit module are connected with each other by means of docking with the board connector or optical connector. For example, there is provided an interface board, and the light source and the optical connector age arranged on the interface board. The reason is that life of the light source and optical fiber is shorter than life of the machine, and the light source and optical fiber must be replaced early.

On the CPU board side, the data signal of a predetermined bit width and a predetermined drive frequency is subjected to parallel-serial-conversion of N:1 by the converter 402 provided with two-way conversion function of parallel-serial-conversion and serial-parallel-conversion in CPU module. After that, the electric signal is converted into an optical signal by the photoelectric converter 404 provided with the two-way conversion function of electricity-light-conversion and light-electricity-conversion. Thus obtained optical signal is inputted into the optical connector 406. When the optical connector 406 is connected with an optical connector attached to the optical fiber 410, the optical connector 406 can be optically connected with the optical fiber 410.

After the optical signal is transmitted by the optical fiber 410, it is incident on the photoelectric converter 424 having the two-way conversion function of electricity-light and light-electricity, and the optical signal is converted into an electric signal by this photoelectric converter 424. Further, by the converter 422 having the two-way conversion function of parallel-serial and serial-parallel, the electric signal is subjected to the conversion of serial-parallel at 1:N and sent to the video board 427 of IOT core section 20. In the same manner, the data signal sent from the video board 427 is processed in the same flow and transmitted to CPU 100 via the same transmission path.

Since the optical signal, which is subjected to parallel-serial-conversion, is transmitted by the optical fiber 410, it is possible to reduce the number of necessary fibers, so that mounting can be easily executed. In this connection, in the cases of parallel-serial-conversion and serial-parallel-conversion conducted by the converters 402, 422, attention should be paid to latency (clock delay).

For example, there is provided a delay compensating section for compensating clock delay caused by parallel-serial-conversion and serial-parallel-conversion executed in the converters 402, 422. In the case where a delay corresponding to 7 clocks is caused in the process of conversion, a shift corresponding to 14 clocks in total is canceled by this delay compensating section. In this connection, it is actually impossible to put back the delay time. Therefore, a processing pulse used in the processing system in the after-stage is delayed by a predetermined period of time. For example, as shown in FIG. 9B, there is provided a delay compensating section 429 for delaying the processing pulse, which is inputted from CPU board onto the video board, by a period of time corresponding to predetermined clocks.

When the board connector, the converters 404, 424 having the two-way conversion function of electricity-light and light-electricity and the optical connectors 406, 426 are respectively arranged on IF board, in the case of a failure of the light source, IF board can be replaced in the portions of the board connector and optical connector. Further, in the case of a failure of the optical fiber, the optical fiber can be replaced at the optical connector.

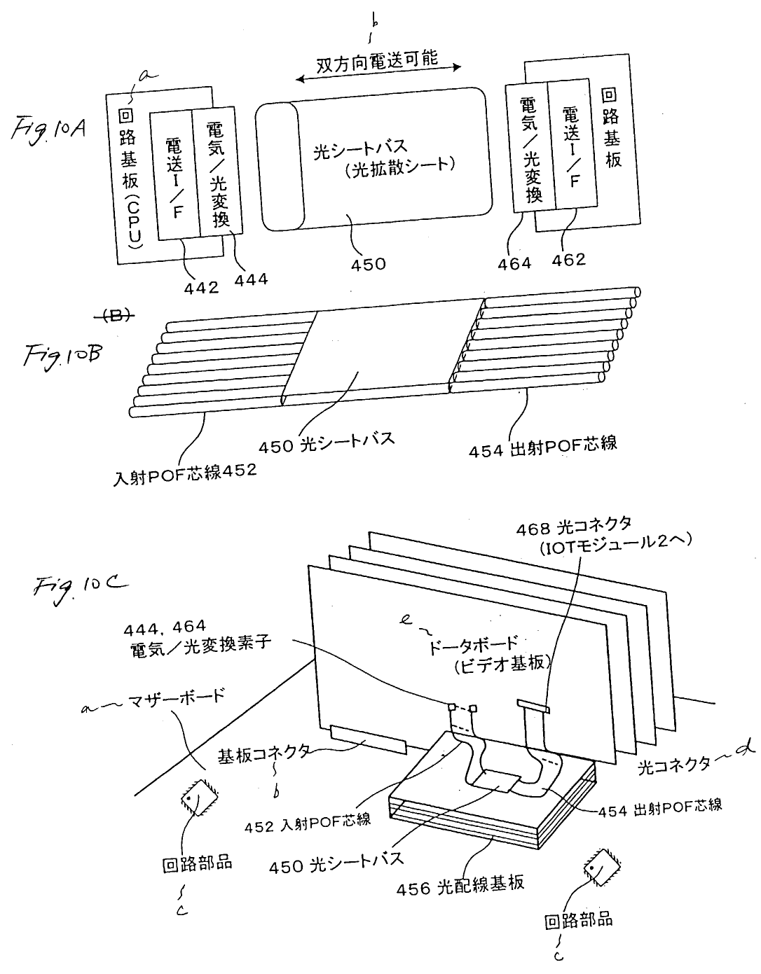

FIG. 10 is a view of a concept for explaining a method of connecting the electric signal with the optical sheet bus. For example, in the case where CPU, the data signal bit width of which is 64, the driving frequency of which is 200 MHz, and the memory are used, the data signal sent from CPU is subjected to parallel-serial-conversion at 8:1 by the electrical transmission I/F section (parallel-serial-converter) 442 in CPU module, and then the electric signal is converted into an optical signal by the electricity-light-converter (photoelectric converter) 444 and optically connected with the optical sheet bus 450. The optical signal which is multiply cast by the diffusion section of the optical, sheet bus 450 is transmitted on each layer of the plane wave-guide of eight layers corresponding to 64 bits at the speed of 1.6 Gbps. After that, the optical signal is converted into an electric signal by the electricity-light-converter 464. Further, this electric signal is subjected to serial-parallel-conversion at 1:8 by the electrical transmission I/F section 462 and then sent to the other circuit modules.

The data signal sent from the other circuit module flows in the same manner and is multiply cast to CPU via the same transmission path. Data transmission from CPU to the other circuit side and data transmission from the other circuit side to CPU side can be simultaneously conducted in the same transmission path, that is, it is possible to conduct the two-way transmission. In order to realize the two-way transmission, not only the optical sheet bus 450 is made to be the two-way but also the electrical transmission I/F sections 442, 462 and the electricity-light transmission sections 444, 464 are made to be the two-way. Further, when the multiplex transmission technique such as a technique of multiplex wave-length is used, the signal inputted into the same transmission path is made multiplex, and the multiple access can be attained between CPU and the other circuit.

In the case of optically connecting the electricity-light-converter 444 with the optical sheet bus 450, there is provided a form in which the light emitting and receiving element of the electricity-light-converter 444 arranged on the board is directly opposed to an incident end face or an emergent end face of the optical sheet bus 450. Other than that, there is provided a form of an optical branch device in which plastic optical fiber POF core wires (incident POF core wires 452 and emergent POF core wire 454) are interposed between the light emitting and receiving element of the electricity-light-converter 444 and the optical sheet bus 450 as shown in FIG. 10B. The forms shown in FIGS. 7 and 8 utilize the form shown in FIG. 10B.

In order to connect the circuit modules by utilizing the form shown in FIG. 10B, for example, as shown in FIG. 10C, the optical wiring board 456 is arranged on the mother board, on which various parts are mounted, by means of solid adhesion, and the daughter board 458 corresponding to each circuit module is vertically arranged via the board connector. The optical sheet bus 450 is arranged on the optical wiring board 456. This optical sheet bus 450 and the daughter board 458 are connected with each other by the incident POF core wires 452 and the emergent POF core wires 454.

When the electricity-light-converters 444, 464 are arranged on the daughter board 458, transmission of the electric signal to the circuit on this daughter board can be gotten. When the optical connector 468 is arranged on the daughter board 458, transmission of the electric signal to IOT module 2 can be gotten by the plastic optical fiber POF.

When the circuit module and the board are connected by utilizing the technique of optical transmission, even when the length of the bus line is extended, the module and the circuit can be connected without causing the problems of EMI (Electro Magnetic Interference), EME (Electro Magnetic Emission) and deformation of a wave-form. As a result, the restrictions placed on the position where the circuit module is arranged can be withdrawn, that is, the layout can be freely determined. Therefore, the processing speed of the apparatus can be increased and further the performance of the apparatus can be enhanced. Furthermore, the function of the apparatus can be multiplied.

For example, when the video system, CPU system and I/O system are connected with each other by the optical interface, it is possible to arrange the video system at a position distant from the print engine 30 (ROS) while CPU system and I/O system are being arranged at position close to the print engine 30 (ROS). For example, the video circuit can be arranged on the video signal I/F section side arranged in the box for the user interface device 8 as shown by the form in FIG. 7. When CPU system and I/O system are connected with each other by the optical interface, while I/O system is being arranged at a position close to the print engine 30 (ROS), CPU system can be arranged at a position distant from the print engine 30 (ROS), for example, in the case of CPU system for the video system, CPU system can be arranged at the same position where the video system is arranged as shown by the form in FIG. 8. IOT core section 20 and the controller to control this IOT core section 20 may be accommodated in different housings.

Since signal lines for the optical interface are concentrated in one portion, it becomes easy to take countermeasures against EMI. In addition to that, when transmission to the optical interface is gotten by utilizing the board connector and the optical connector, the light source and the optical fiber can be easily replaced in the case where a failure is occurred. Therefore, the maintenance property can be enhanced. Further, since the metallic interface is not used, it is possible to avoid the occurrence of a drop of voltage of the electric power source. Conventionally, since the circuit members for IOT core section 20 are arranged on the back panel, which is located distant from the electric power source section, and the connection is made by the metallic interface, a drop of voltage is caused between the electric power source section and the back panel. There is a big difference between the form of the invention and the above conventional form.

The present invention is explained above referring to the embodiments. However, it should be noted that the present invention is not limited to the above specific embodiment. Variations may be made by one skilled in the art without departing from the spirit and scope of the invention. Such variations, in which changes or improvements are made, are included in the scope of the present invention.

The present invention is not restricted by the above embodiments accomplished according to the claims. All combinations of the characteristics explained in the embodiments are not necessarily required by the means for solution of the invention. The above embodiments include the inventions accomplished at various stages. When a plurality of components of the invention disclosed are combined with each other, it is possible to extract various inventions. Even when several components of the invention shown in the embodiments are deleted, as long as the effect can be provided, it is possible to extract the constitution, from which several components of the invention are deleted, as the present invention.

For example, in the above embodiment, explanations are made into a case in which the electrophotographic process is utilized as a print engine which is a primary portion for forming a visual image on a recording medium. However, it should be noted that the present invention is not limited to the above specific embodiment. For example, it is possible to apply the present invention to an image forming apparatus which is composed in such a manner that a visual image is formed on a sheet of plain paper or a sheet of thermosensitive paper by an engine having an image forming mechanism of a thermosensitive type, thermal transfer type, ink jet type or any other conventional type.

In the above embodiment, explanations of the image forming apparatus are made into a printer having a print engine in which the electrophotographic process is utilized. However, the image forming apparatus is not limited to the printer. The image forming apparatus includes a color copier and facsimile having a printing function by which an image can be formed on a recording medium.

In the above embodiment, explanations are made into a mechanism in which the optical transmission medium is used for the electric signal transmission between the functional modules in the image forming apparatus having the image forming section from which an image recorded on a predetermined recording medium is outputted according to the inputted image data. However, the above method of getting a transmission of the electric signal by using the optical transmission medium is not limited to the image forming apparatus. As long as the apparatus is provided with a plurality of circuit modules, the method can be applied to any apparatus.

As described above, a transmission of the signal between the functional modules is gotten by utilizing the optical transmission medium. Therefore, even when a plurality of functional modules are arranged distant from each other, the problems of EMI (Electro Magnetic Interference), EME (Electro Magnetic Emission) and deformation of a wave-form are not caused.

Accordingly, for example, the video circuit, which must be conventionally arranged close to the print engine, can be moved to a position distant from the print engine. In this way, the degree of freedom of the position, at which the functional module circuit is arranged, can be remarkably enhanced. Due to the foregoing, the processing speed of the system can be increased, the performance of the system can be enhanced and the function of the system can be flexibly multiplied.

What is claimed is:

1. A processor to conduct predetermined processing comprising:
an optical interface section to get transmission of an electric signal by an optical transmission medium between a plurality of module circuits corresponding to the respective functional portions of said processor.

2. The processor according to claim 1, further comprising:
an image forming section to form an image on a predetermined recording medium and output thereof according to image data inputted.

3. The processor according to claim 1, wherein
said plurality of functional module circuits are respectively mounted on different circuit boards, and
said optical interface section gets transmission of the electric signal by the optical transmission medium between said respective circuit boards.

4. The processor according to claim 1, wherein
said optical interface section uses an optical transmission member in which a plurality of beams of signal light are incident on an end face of a plane wave guide having a diffusion optical system, and
the beams of signal light are diffused in said plane wave guide and outputted from an opposed end face.

5. The processor according to claim 1, wherein
said optical interface section includes:
a parallel-serial converter to convert a parallel type electric signal into a serial type electric signal;
a first photoelectric converter to convert a serial type electric signal, which is converted by said parallel-serial converter, into a beam of signal light and make the beam of signal light be incident on the optical transmission medium;
a second photoelectric converter to receive the beam of signal light passing through the optical transmission medium and convert the beam of signal light into a serial type electric signal; and
a serial-parallel converter to convert the serial type of electric signal, which is converted by said second photoelectric converter, into a parallel type electric signal.

6. The processor according to claim 1, further comprising:
a delay compensation section to compensate a clock delay caused by at least one of the conversion by said parallel-serial converter and the conversion by said serial-parallel converter.

7. The processor according to claim 1, further comprising:
a connector section composed so that at least one of said first photoelectric converter and said second photoelectric converter can be replaced.

8. The processor according to claim 1, further comprising:
an optical connector section composed so that the optical transmission medium can be replaced.

9. The processor according to claim 1, further comprising:
a video circuit to process image data used in a marking section relating to image formation as a functional module circuit; and
a controller to control operation of said video circuit, wherein
said optical interface section gets transmission of an electric signal between said video circuit and said controller by the optical transmission medium.

10. The processor according to claim 9, further comprising:
an input and output interface section to get an interface between said functional module circuit and said functional operation section operating corresponding to said respective functional portions of said processor, wherein
said optical interface section gets transmission of the electric signal between said controller and said input and output interface section by the optical transmission medium.

11. The processor according to claim 9, wherein
said video circuit is accommodated in a housing different from a housing in which said controller is accommodated.

12. The processor according to claim 10, wherein
said video circuit is accommodated in a housing different from a housing in which said input and output interface section is accommodated.
